(19) United States
(12) Patent Application Publication
(10) Pub. No.: US 2010/0013978 A1
(43) Pub. Date: Jan. 21, 2010

(54) ELECTRONIC DEVICE WITH IMAGE CAPTURING FUNCTION

(75) Inventors: FU-LIN YANG, Tu-Cheng (TW); YU-KAI KAO, Tu-Cheng (TW); PEI-YI OU-YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/264,266

(22) Filed: Nov. 4, 2008

(30) Foreign Application Priority Data
Jul. 17, 2008 (CN) 200810302780.X

(51) Int. Cl. H04N 5/225

(52) U.S. Cl. 348/335; 348/E05.024

(57) ABSTRACT

An electronic device includes a lens body, a rotatable portion, a base, and a main body. The lens body contains a lens module. The rotatable portion is secured to the lens body, and defines a number of grooves on the circumference surface thereof. The base defines a through hole with the rotatable portion received therein. An elastic sheet is disposed at a lateral side of the through hole and has a protrusion projecting into the through hole for engaging with the grooves of the rotatable portion. The main body is secured with the base.

### TECHNICAL FIELD

The present invention relates to electronic devices with image capturing function and, particularly, to an electronic device with a rotatable lens module.

### DESCRIPTION OF THE RELATED ART

At present, many electronic devices, such as mobile phone, PDA, and so on, have embedded lens modules therein. Mostly, the lens module is fixed on a surface of the electronic device stationarily, and users need to rotate the whole electronic device when they want to change a view angle. That would be inconvenient for users to view an image of an object on a screen of the electronic device. In order to overcome the above problem, electronic devices with rotatable lens modules were developed. However, in the electronic device with rotatable lens module, the lens module is usually difficult to stay at a position steadily. As a result, the lens module usually changes its position because of shaking during photographing, which would seriously affect the quality of the image captured by the lens module.

What is needed, therefore, is an electronic device with a rotatable lens module which can overcome the above-described problem.

### BRIEF DESCRIPTION OF THE DRAWINGS

Many aspects of the present electronic device with image capturing function can be better understood with references to the accompanying drawings. The components in the drawing are not necessarily drawn to scale, the emphasis instead being placed upon clearly illustrating the principles of the present electronic device with image capturing function.

FIG. 1 is a cut-away view of an electronic device with a lens body and a rotation unit according to an exemplary embodiment.

FIG. 2 is an exploded, schematic view of the lens body and the rotation unit of the electronic device of FIG. 1.

FIG. 3 is a schematic view of the lens body and the rotation unit of FIG. 2 after being assembled.

FIGS. 4-6 are schematic, magnified views of the rotation unit of FIG. 2 at three operation states respectively.

### DETAILED DESCRIPTION OF THE EMBODIMENTS

Embodiments of the present invention will now be described in detail below, with references to the accompanying drawings.

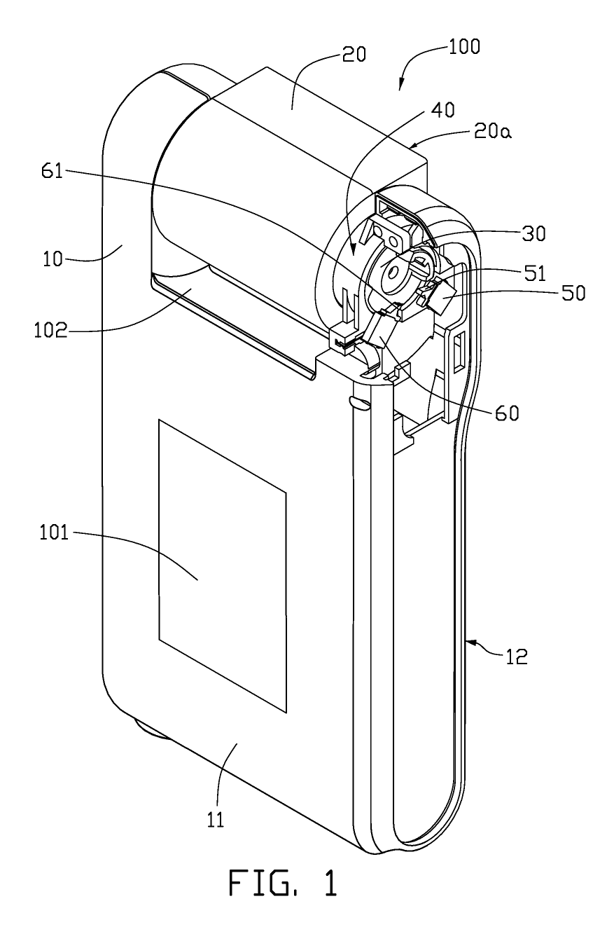

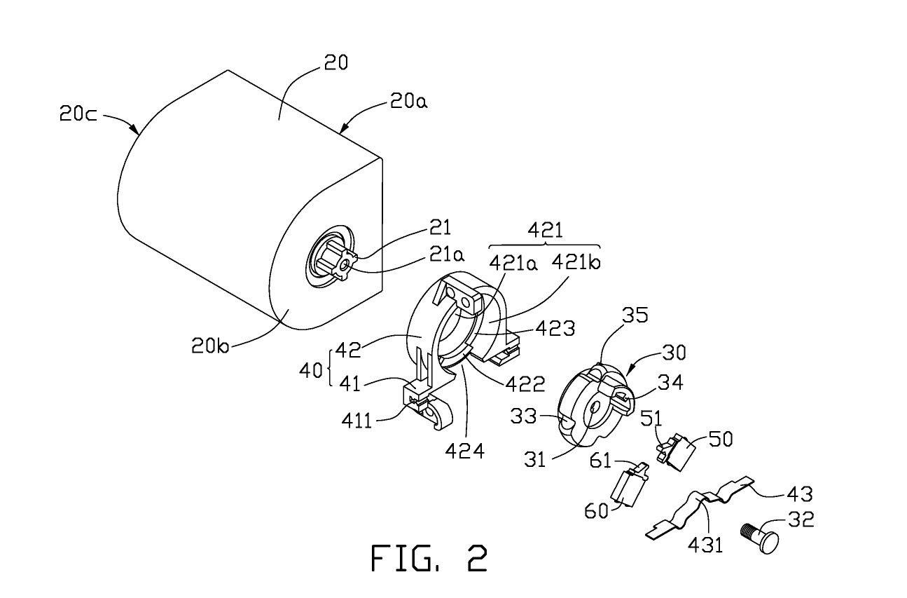

Referring to FIGS. 1 to 3, an electronic device 100 according to an exemplary embodiment is shown. The electronic device 100 includes a main body 10, a lens body 20 containing a lens module (not visible) disposed on a lateral surface 20a, and a rotation unit including a rotatable portion 30 and a base 40.

The main body 10 includes a first surface 11 and an opposite second surface 12. A screen 101 is disposed on the first surface 11. The screen 101 is electrically connected to the lens module in the lens body 20 to display images obtained by the lens module. In the present embodiment, the main body 10 defines a recess 102 for receiving the lens body 20. Furthermore, the lens module in the lens body 20 can be rotated to face the bottom of the recess 102 for concealing when not in use without the need of a complicated cap structure to protect it from dust, undue force etc.

In the present embodiment, the lens body 20 includes a first end surface 20b and a second end surface 20c opposite to the first end surface 20b. The first and second end surfaces 20b and 20c are both connected with the lateral surface 20a. The lens body 20 has a pivot shaft 21 running through the first end surface 20b and the second end surface 20c and protruding therefrom. The pivot shaft 21 defines a screw hole 21 a on the end surface thereof away from the lens body 20.

The rotatable portion 30 is fixed to the pivot shaft 21, thus, the rotation portion 30 can be rotated together with the lens body 20. In the present embodiment, the rotatable portion 30 defines a center hole 31 corresponding to the screw hole 21a of the pivot shaft 21, and the rotatable portion 30 is fixed to the pivot shaft 21 by inserting a screw 32 into the screw hole 21a through the center hole 31. The rotatable portion 30 is substantially a cylinder-shaped and defines a number of grooves 33 on the circumference surface thereof. In the present embodiment, four grooves 33 are defined on the circumference surface of the rotatable portion 30, and the four grooves 33 are evenly spaced apart from each other. It is understood that, the number of the grooves 33 can also be three, five and so on. The rotatable portion 30 also includes an operating portion 34 on an end surface thereof facing away from the lens body 20, and an arcuate protrusion 35 on the other end surface of the rotatable portion 30. The arcuate protrusion 35 is located between two grooves 33.

The base 40 includes a base portion 41, a receiving portion 42 and an elastic sheet 43. The base portion 41 is secured on the main body 10 of the electronic device 100 and defines a slot 411 for receiving the elastic sheet 43. The base portion 41 is configured for supporting the receiving portion. In the present embodiment, the base portion 41 is integrally formed with the receiving portion 42 and a casing of the main body 10.

The receiving portion 42 defines a stepped through hole 421 with its center axis parallel to the pivot shaft 21. The through hole 421 includes a first portion 421a for receiving the pivot shaft 21 and a second portion 421b for receiving the rotatable portion 30. The diameter of the second portion 421b is substantially equal to that of the rotatable portion 30. The diameter of the second portion 421b is bigger than that of the first portion 421a to form a step 423 between the first portion 421a and the second portion 421b. The side wall of the second portion 421b defines a cutout 424 communicating with the slot 411 of the base portion 41. The receiving portion 42 has an arcuate projection 422 extending from the step 423 into the second portion 421b and adjacent to the cutout 424. The projection 422 cooperates with the protrusion 35 of the rotatable portion 30 to limit the rotating direction of the rotatable portion 30.

The elastic sheet 43 is a strip with two ends thereof receiving in the slot 411. The center of the elastic sheet 43 forms a protrusion 431 projecting into the second portion 421b via the cutout 424. The protrusion 431 is configured for engaging with the grooves 33 of the rotatable portion 30 for accurately positioning the rotatable portion 30.

In the present embodiment, the electronic device 100 also includes a first switch 50 for controlling the electronic device 100 to turn on or off an image capturing mode, and a second switch 60 for controlling the electronic device 100 whether to inverse the image displayed on the screen 101.

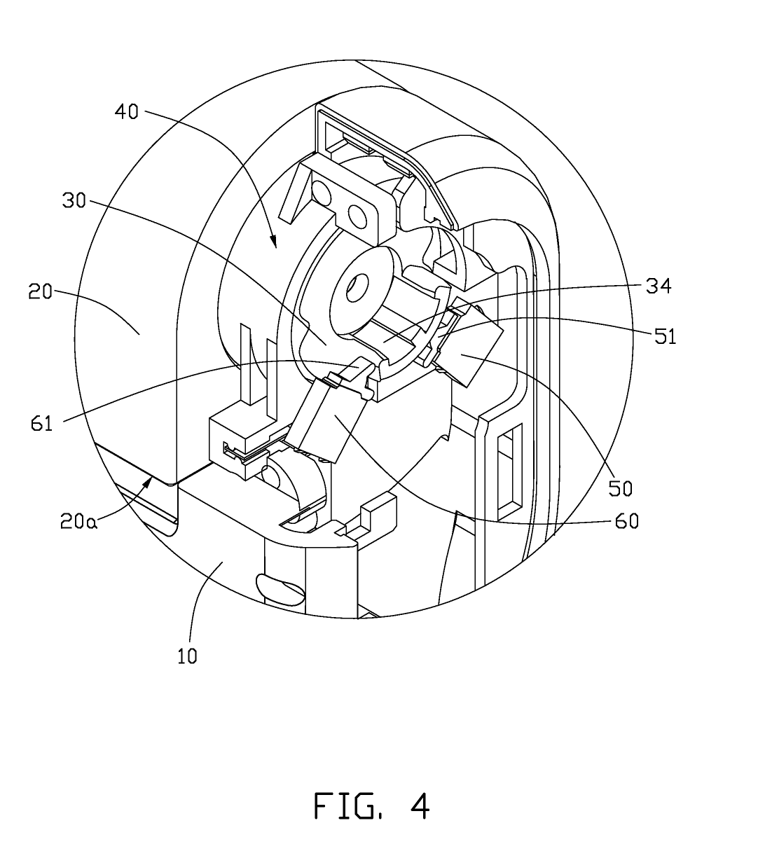

The first switch 50 has a trigger 51 which can be pressed by the operating portion 34 of the rotatable portion 30. Referring to FIG. 4, when the lateral surface 20a of the lens body 20 faces the bottom of the recess 102 of the main body 10, the trigger 51 is pressed by the operating portion 34 of the rotatable portion 30, the first switch 50 will turn off the image capturing mode of the electronic device 100. When the trigger 51 is not pressed by the operating portion 34 of the rotatable portion 30, such as in FIGS. 1 and 5-6, the first switch 50 will turn on the image capturing mode of the electronic device 100.

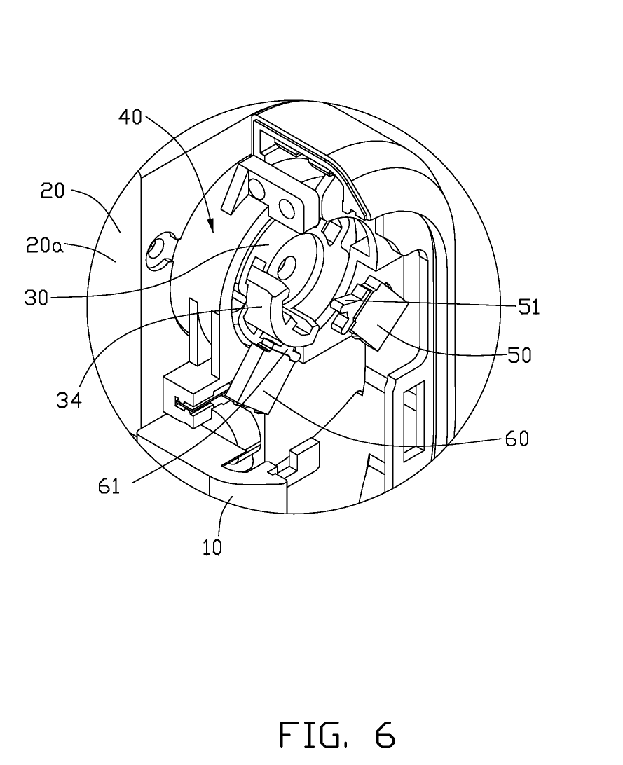

The second switch 60 is different from the first switch 50. Referring to FIG. 6, when a trigger 61 of the second switch 60 is pressed by the operating portion 34, the electronic device 100 will switch the orientation of the image displayed on the screen 101, for example, rotating the image displayed on the screen 101 for about 180 degrees. When the trigger 61 is released by the operating portion 34, such as in FIGS. 1 to 5, the electronic device 100 will not change the orientation of the image displayed on the screen 101. In FIG. 6, the upper side and the lower side of the lens module on the lateral surface 20a of the lens body 20 is inversed relative to the electronic device 100 in the FIG. 1, use the second switch 60 can ensure the image displayed on the screen 101 with a correct orientation. Both the trigger 51 and the trigger 61 are elastic and can return to a position before or after being pressed.

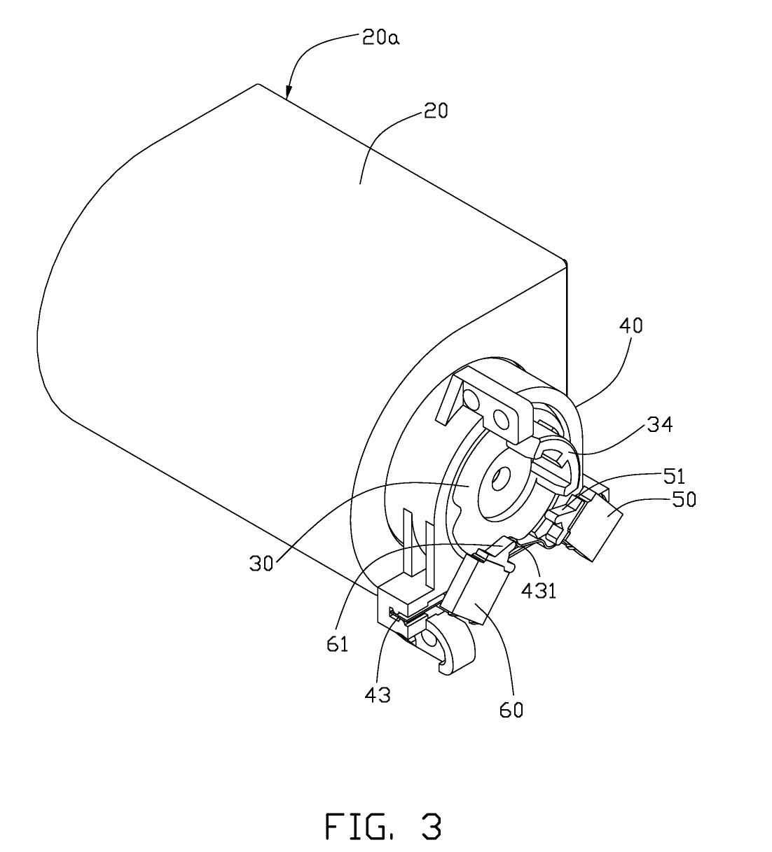

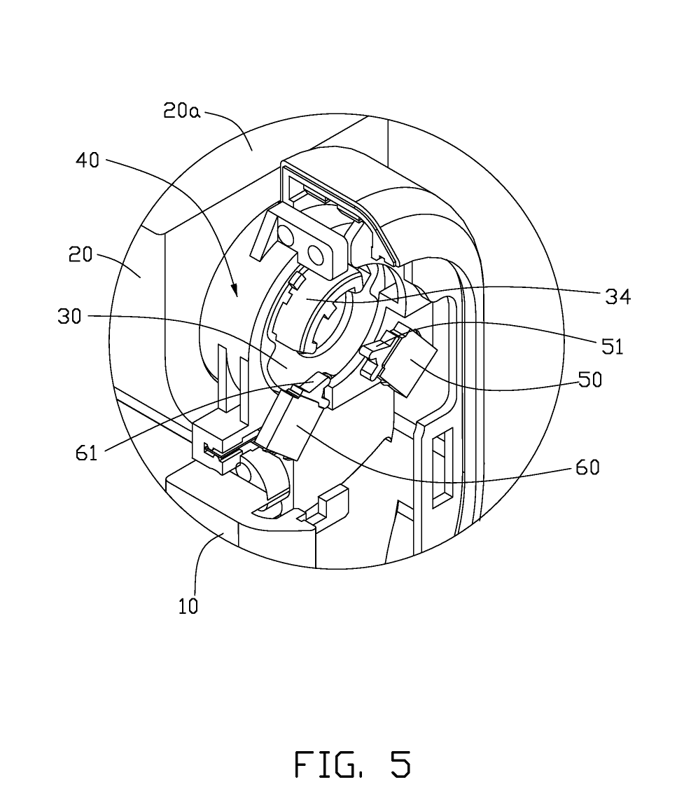

In the present embodiment, because the rotatable portion 30 defines four grooves 33 on the circumference surface thereof, the lens body 20 has four operation state. Referring to FIG. 4, in a first operation state, the lateral surface 20a of the lens body 20 faces the bottom of the recess 102 of the main body 10, the trigger 51 is pressed by the operating portion 34 of the rotatable portion 30, and the trigger 61 is in a free state. The image capturing mode of the electronic device 100 is closed. Referring to FIG. 3, in a second operation state, the lateral surface 20a of the lens body 20 faces the same direction as the second surface 12 of the main body 10, the trigger 51 is released and the trigger 61 is in a free state, and the first switch 50 will turn on the image capturing mode of the electronic device 100. Referring to FIG. 5, in a third operation state, the lateral surface 20a of the lens body 20 faces away from the bottom of the recess 102 of the main body 10, both of the trigger 51 and the trigger 61 are not pressed, the first switch 50 keeps the image capturing mode of the electronic device 100 turned on. Referring to FIG. 6, in a fourth operation state, the lateral surface 20a of the lens body 20 faces the same direction as the first surface 11 of the main body 10, the trigger 51 is not pressed and the trigger 61 is pressed, and the second switch 60 will inverse the image displayed on the screen 101 of the electronic device 100.

It is understood that the electronic device 100 can also has two rotation units, each rotation unit includes a rotatable portion 30 and a base 40 for engaging with an end of the pivot shaft of the lens body 20. Furthermore, the rotating direction of the rotatable portion 30 also need not be limited, and the arcuate projection 422 of the base portion 41 and the protrusion 35 of the rotatable portion 30 can be removed.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. An electronic device comprising:
a lens body containing a lens module;
a rotatable portion secured to the lens body, the rotatable portion defining a plurality of grooves on the circumference surface thereof,
a base defining a through hole with the rotatable portion received therein, an elastic sheet being disposed at a lateral side of the through hole and having a protrusion projecting into the through hole for engaging with the grooves of the rotatable portion; and
a main body with the base secured thereon.

2. The electronic device as claimed in claim 1, wherein the main body defines a recess for receiving the lens body.

3. The electronic device as claimed in claim 1, wherein the main body comprises a screen electrically connected to the lens module in the lens body, and is capable of displaying images obtained by the lens module.

4. The electronic device as claimed in claim 1, wherein the lens body comprises a pivot shaft extending from two opposite end surfaces of the lens body; and one end of the shaft is secured to the rotatable portion.

5. The electronic device as claimed in claim 4, wherein the pivot shaft secured to the rotatable portion defines a screw hole on an end surface thereof away from the lens body, and the rotatable portion defines a center hole corresponding to the screw hole, the pivot shaft is secured to the rotatable portion by inserting a screw into the screw hole through the center hole.

6. The electronic device as claimed in claim 1, wherein the base is integrally formed with a casing of the main body.

7. The electronic device as claimed in claim 1, wherein the base comprises a base portion and the receiving portion, the base portion is secured to the main body and defines a slot for latching the elastic sheet, the receiving portion defines the through hole and defines a cutout communicating with the slot to admitting the protrusion of the elastic sheet projecting into the through hole.

8. The electronic device as claimed in claim 7, wherein the base portion is integrally formed with the receiving portion.

9. The electronic device as claimed in claim 1, wherein plurality of grooves on the circumference surface of the rotatable portion comprises four grooves and the four grooves are evenly spaced apart from each other.

10. The electronic device as claimed in claim 1, wherein the rotatable portion further comprises an operating portion on an end surface thereof away from the lens body, the electronic device further comprises a first switch capable of turning on or off an image capturing mode of the electronic device by unpressing or pressing a trigger thereof, the trigger is capable of being pressed by the operating portion.

11. The electronic device as claimed in claim 10, wherein the lens module is disposed in a lateral surface of the lens body, when the lens body is rotated to a position with the lateral surface thereof facing to the main body, the operating portion will press the trigger of the first switch, and when the lateral surface of the lens body is not facing to the main body, the trigger of the first switch will keep being released.

12. The electronic device as claimed in claim 3, wherein the rotatable portion further comprises an operating portion on an end surface thereof away from the lens body, the electronic device further comprises a second switch capable of inversing the image displayed on the screen by pressing a trigger thereof, the trigger is capable of being pressed by the operating portion.

13. The electronic device as claimed in claim 12, wherein the lens module is disposed in a lateral surface of the lens body, when the lens body is rotated to a position with the lateral surface thereof facing to a direction same to the screen, the operating portion will press the trigger of the second switch.

14. An electronic device comprising:
a main body;
a lens body; and
a rotation unit connecting the lens module to the main body and configured for make the lens module capable of rotating relative to the main body; the rotation unit comprising:
a base secured to the main body and comprising a positioning member;
a rotatable portion secured to the lens module and defining a plurality of positions and capable of engaging with the positioning member to position the lens module relative to the main body when rotating the lens body.

15. The electronic device as claimed in claim 14, wherein the base defines a through hole with the rotatable portion received therein, the positioning member is an elastic sheet being disposed at a lateral side of the through hole and having a protrusion projecting into the through hole for engaging at the positions of the rotatable portion.

16. The electronic device as claimed in claim 15, wherein the positions of the rotatable portion are a plurality of grooves on the circumference surface thereof.

17. The electronic device as claimed in claim 14, wherein the main body defines a recess for receiving the lens module.

18. The electronic device as claimed in claim 14, wherein the lens body comprises a pivot shaft running through two opposite end surfaces of the lens body, and is secured to the rotatable portion.

19. The electronic device as claimed in claim 14, wherein the base is integrally formed with a casing of the main body.

20. The electronic device as claimed in claim 15, wherein the base further comprises a base portion and the receiving portion, the base portion is secured to the main body and defines a slot for latching the elastic sheet, the receiving portion defines the through hole and defines a cutout communicating with the slot to admitting the protrusion of the elastic sheet projecting into the through hole.
